(19) United States
(12) Patent Application Publication
(10) Pub. No.: US 2025/0078834 A1
(43) Pub. Date: Mar. 6, 2025

(54) PLAYBACK MODE SWITCHING METHOD AND MULTIMEDIA PLAYBACK APPARATUS THEREOF

(71) Applicant: BENQ CORPORATION, Taipei City (TW)

(72) Inventor: Yu-Ching Tung, Taipei City (TW)

(73) Assignee: BENQ CORPORATION, Taipei City (TW)

(21) Appl. No.: 18/772,299

(22) Filed: Jul. 15, 2024

(30) Foreign Application Priority Data
Aug. 29, 2023 (TW) 112132404

(51) Int. Cl. G10L 15/22; G10L 15/08

(52) U.S. Cl. CPC G10L 15/22; G10L 15/083; G10L 2015/088; G10L 2015/223

(57) ABSTRACT

A playback mode switching method includes a multimedia playback apparatus establishing an index table corresponding to a plurality of preset keyword data and a plurality of playback modes, the multimedia playback apparatus playing multimedia content, the multimedia playback apparatus extracting a frame image from the multimedia content and generating a query information to query a network artificial intelligence model, the network artificial intelligence model transmitting a first keyword data back to the multimedia playback apparatus according to the query information, and the multimedia playback apparatus analyzing the first keyword data and the index table to determine whether to perform a mode switching operation for adjusting a playback parameter setting of the multimedia content.

### BACKGROUND OF THE INVENTION

### 1. Field of the Invention

The present invention relates to a playback mode switching method and a multimedia playback apparatus thereof, and more specifically, to a playback mode switching method analyzing a first keyword data returned by a network artificial intelligence model according to a frame image of a multimedia content to determine whether to perform a mode switching operation and a multimedia playback apparatus thereof.

### 2. Description of the Prior Art

In general, a conventional multimedia playback apparatus (e.g. a projector or a display monitor) usually has a playback parameter adjusting function for a user to adjust a multimedia content displayed by the multimedia playback apparatus to meet his viewing needs, such as performing an OSD (On Screen Display) function of a display monitor by manually pressing a button set on the display monitor or by software. However, since there are so many playback parameters (e.g. brightness, contrast, definition, saturation, etc.) provided by the multimedia playback apparatus for the user to adjust, it may cause a time-consuming and strenuous playback parameter adjusting process. Although the multimedia playback apparatus can provide different playback modes (e.g. a theater mode and a game mode) built therein for the user to choose from, this design still requires the user to manually switch the multimedia playback apparatus from one playback mode to anther playback mode. Thus, the aforesaid design is not convenient and quick enough in playback mode switching.

### SUMMARY OF THE INVENTION

The present invention provides a playback mode switching method including a multimedia playback apparatus establishing an index table corresponding to a plurality of preset keyword data and a plurality of playback modes, the multimedia playback apparatus playing multimedia content, the multimedia playback apparatus extracting at least one frame image from the multimedia content and generating at least one query information to query a network artificial intelligence model, the network artificial intelligence model transmitting a first keyword data back to the multimedia playback apparatus according to the query information, and the multimedia playback apparatus analyzing the first keyword data and the index table to determine whether to perform a mode switching operation for adjusting a playback parameter setting of the multimedia content.

The present invention further provides a multimedia playback apparatus connected to a network artificial intelligence model. The multimedia playback apparatus includes a multimedia playback device, a multimedia processing device, and a network transmission device. The multimedia playback device is for playing a multimedia content. The multimedia processing device is electrically connected to the multimedia playback device, for establishing in advance an index table corresponding to a plurality of preset keyword data and a plurality of playback modes, extracting at least one frame image from the multimedia content, and generating at least one query information according to the at least one frame image. The network transmission device is electrically connected to the multimedia processing device, for transmitting a first keyword data returned by the network artificial intelligence model according to the at least one query information back to the multimedia processing device. The multimedia processing device analyzes the first keyword data and the index table to determine whether to control the multimedia playback device to perform a mode switching operation for adjusting a playback parameter setting of the multimedia content.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a multimedia playback apparatus according to an embodiment of the present invention.

FIG. 2 is a flowchart of a playback mode switching method according to an embodiment of the present invention.

FIG. 3 is a flowchart of a source analysis method according to an embodiment of the present invention.

### DETAILED DESCRIPTION

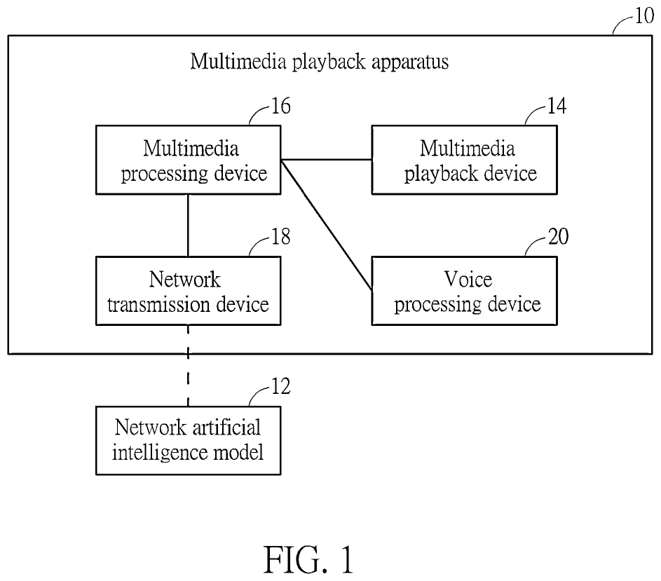

Please refer to FIG. 1, which is a functional block diagram of a multimedia playback apparatus 10 according to an embodiment of the present invention. The multimedia playback apparatus 10 could be a common multimedia device (e.g., a DLP (Digital Light Processing) projector or a smart LCD (Liquid Crystal Display) TV, but not limited thereto) having a multimedia playback function and a playback mode switching function (e.g., switching the multimedia playback apparatus 10 to a theater mode, a game mode or a movie mode) and could be connected to a network artificial intelligence model 12 (e.g., GPT-4 (Generative Pre-trained Transformer 4)) in a wireless or wired connection manner. As shown in FIG. 1, the multimedia playback apparatus 10 includes a multimedia playback device 14, a multimedia processing device 16, and a network transmission device 18.

The multimedia playback device 14 (e.g., an image projection lens or an LCD display panel) could be used to play multimedia content (e.g., concert videos, video games, movies, etc.). The multimedia processing device 16, which could be a microprocessor for image processing (e.g., a CPU (Central Processing Unit) or a GPU (Graphics Processing Unit)) in the multimedia playback apparatus 10, is electrically connected to the multimedia playback device 14. The multimedia processing device 16 establishes an index table corresponding to preset keyword data and playback modes for subsequent keyword analysis, and extracts frame images (e.g., concert scenes, game title images, or movie title images) from the multimedia content played by the multimedia playback device 14 for generating query information. The network transmission device 18 could be a common network card (e.g., a wireless network card) for network transmission and is electrically connected to the multimedia processing device 16. As such, the network transmission device 18 can upload query information to the network artificial intelligence model 12 and transmit keyword data returned by the network artificial intelligence model 12 based on the query information to the multimedia processing device 16. In this way, the multimedia processing device 16 can analyze the keyword data from the network artificial intelligence model 12 and the aforesaid index table to determine whether to control the multimedia playback device 14 to perform a mode switching operation for adjusting a playback parameter setting of the multimedia content. In such a manner, the multimedia playback apparatus 10 can be automatically switched to a proper playback mode for meeting a user's current viewing needs, so as to improve the multimedia viewing experience of the user.

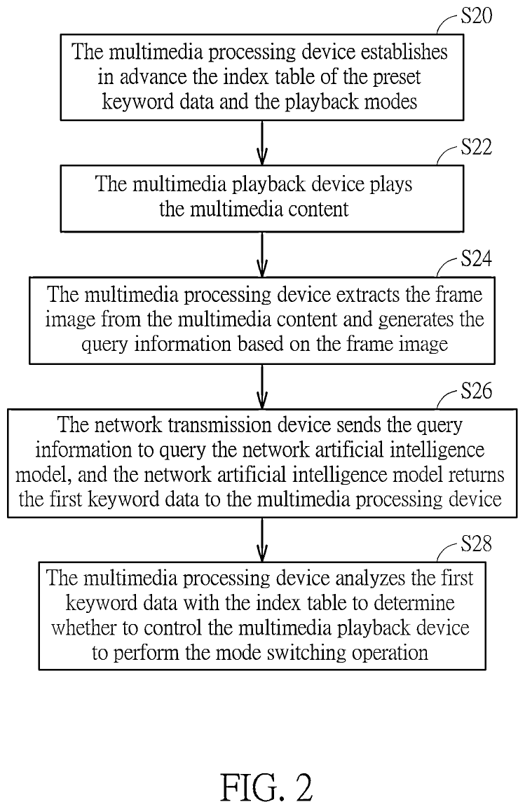

Please refer to FIG. 1 and FIG. 2. FIG. 2 is a flowchart of a playback mode switching method according to an embodiment of the present invention. The playback mode switching method of the present invention utilizing the multimedia playback apparatus 10 to perform a mode switching operation includes the following steps.
Step S20: The multimedia processing device 16 establishes in advance the index table of a plurality of preset keyword data and a plurality of playback modes.
Step S22: The multimedia playback device 14 plays the multimedia content.
Step S24: The multimedia processing device 16 extracts the frame image from the multimedia content and generates the query information based on the frame image.
Step S26: The network transmission device 18 sends the query information to query the network artificial intelligence model 12, and the network artificial intelligence model 12 returns a first keyword data based on the query information to the multimedia processing device 16.
Step S28: The multimedia processing device 16 analyzes the first keyword data with the index table to determine whether to control the multimedia playback device 14 to perform the mode switching operation.

More detailed description for the aforesaid steps is provided as follows. Firstly, for providing an instant search function, in Step S20, the multimedia processing device 16 establishes in advance the index table of the plurality of preset keyword data and the plurality of playback modes, serving as a reference for subsequent playback mode switching. For example, in the index table established by the multimedia processing device 16, one of the preset keyword data could include a piano performer (such as Yo-Yo Ma) and piano performance, a corresponding index is “concert”, and a corresponding playback mode to which the multimedia processing device 16 needs to switch the multimedia playback device 14 is “theater mode”. Alternatively, another preset keyword data could include a golfer (e.g., Tiger Woods) and a golf course, a corresponding index is “golf match”, and a corresponding playback mode to which the multimedia processing device 16 needs to switch the multimedia playback device 14 is “golf mode”. As for the index design of other preset keyword data and corresponding playback modes, it could be reasoned by analogy according to the aforesaid examples and may vary according to the actual playback applications of the multimedia playback apparatus 10. Further details are omitted here for simplicity.

Next, in Step S22, the user could control the multimedia playback device 14 to play the desired multimedia content, such as projecting concert videos or game scenes. At this time, the multimedia processing device 16 could extract at least one frame image (e.g., a first frame image, but not limited thereto, meaning that the present invention could also adopt other frame image or multiple frame images in a certain period of playback time) from the multimedia content and generate the query information to query the network artificial intelligence model 12 (Step S24). More specifically, in this embodiment, to achieve quick querying, the aforementioned query information could preferably be transmitted to the network artificial intelligence model 12 in the form of a closed-ended choice question about the image type (but not limited thereto). For example, the multimedia processing device 16 could combine the extracted frame image and the closed-ended choice question composed of text (e.g., “What is this image? (1) Concert (2) Scenery (3) Playground (4) Golf course (5) None of the above”) to generate the query information for the network artificial intelligence model 12. Once the network transmission device 18 sends the query information to the network artificial intelligence model 12, the network artificial intelligence model 12 can generate the corresponding first keyword data and return the corresponding first keyword data to the multimedia processing device 16 (Step S26) for subsequent keyword analysis. To be noted, during the aforesaid process, the multimedia playback apparatus 10 could preferably adopt real-time translation (but not limited thereto). For example, the multimedia processing device 16 could utilize a translation service (e.g., a translation application or a real-time translation service provided by the network artificial intelligence model 12) to convert a language of the query information (e.g., Chinese) into a default language (e.g., English) of the network artificial intelligence model 12, so as to enhance the query accuracy, enabling the network artificial intelligence model 12 to return a more precise and reasonable answer. Furthermore, in practice, the multimedia playback apparatus 10 could set the network artificial intelligence model 12 to a projector expert mode in advance, or utilize the network transmission device 18 to actively send the index table to the network artificial intelligence model 12, assisting the network artificial intelligence model 12 to continuously evolve in the projector field, thereby enabling the network artificial intelligence model 12 to provide more professional answers.

Upon receiving the first keyword data returned by the network artificial intelligence model 12, the multimedia processing device 16 can analyze and compare the first keyword data and the pre-established index table of the multimedia processing device 16 (Step S28). This step could be done by using a parsing method (not limited thereto), and the related description for the parsing method is commonly seen in the prior art and omitted herein. As such, the multimedia processing device 16 can determine whether there exists any preset keyword data in the index table that matches the first keyword data, which serves as a reference for subsequent playback mode switching.

In the aforementioned process, when the multimedia processing device 16 determines that the first keyword data matches one of the preset keyword data, such as the network artificial intelligence model 12 returning the first keyword data for “(1) Concert”, and the multimedia processing device 16 determines the first keyword data matches a concert index in the index table, the multimedia processing device 16 can then control the multimedia playback device 14 to perform the mode switching operation. That is, according to the correspondence relationship between the concert and the theater mode in the index table, the current playback mode of the multimedia playback device 14 is switched to a theater mode for adjusting the playback parameter setting of the multimedia content (e.g., enhancing the bass effect or increasing the image brightness and contrast, but not limited thereto). In such a manner, the multimedia playback apparatus 10 can be automatically switched to a preferable image playback mode suitable for the user's current viewing needs without any manual operation, so as to efficiently improve the multimedia viewing experience of the user. On the contrary, when the multimedia processing device 16 determines that the first keyword data does not match any preset keyword data, such as the network artificial intelligence model 12 returning the first keyword data for “(5) None of the above”, and the multimedia processing device 16 determines that the first keyword data cannot match any index relationship in the index table, the multimedia processing device 16 does not perform the mode switching operation, so as to improve the efficiency of the multimedia playback apparatus 10 in mode switching.

It should be noted that, in the aforesaid keyword mismatch situation, the multimedia processing device 16 could also continue to query the network artificial intelligence model 12 in a batch manner to subsequently establish new index relationships in the index table. That is, the multimedia processing device 16 could continue to transmit the query information in the form of a question (e.g., “What is this image?”) about the image type to the network artificial intelligence model 12 (but not limited thereto). Thus, after the network transmission device 18 sends the aforementioned query information to the network artificial intelligence model 12, the network artificial intelligence model 12 can generate a second keyword data based on the query information. The multimedia processing device 16 can then establish a new index relationship between the second keyword data and one of the playback modes in the aforementioned index table. For example, if the second keyword data returned by the network artificial intelligence model 12 is “scenery”, the multimedia processing device 16 can establish a new index relationship for scenery corresponding to a high brightness mode, further enhancing the functionality of the multimedia playback apparatus 10 in playback mode switching.

In summary, compared with the prior art, the present invention, by analyzing the first keyword data returned by the network artificial intelligence model based on the frame image of multimedia content with the index table, determines whether to perform the mode switching operation of the multimedia playback apparatus. As such, the multimedia playback apparatus can be automatically switched to a preferable playback mode suitable for the user's current viewing needs without any manual operation. That is, the present invention can efficiently solve the prior art problem that the playback parameter adjusting process is time-consuming and strenuous, so as to greatly improve operational convenience of the multimedia playback apparatus and optimize the multimedia viewing experience of the user.

In practical applications, the multimedia playback apparatus 10 could also provide a voice query function. As shown in FIG. 1, the multimedia playback apparatus 10 could further include a voice processing device 20. The voice processing device 20 could be a voice recognition n apparatus commonly applied to voice input/output applications (the related description is commonly seen in the prior art and omitted herein) and electrically connected to the multimedia processing device 16, for establishing a voice service on the multimedia playback apparatus 10. Via the aforesaid design, the voice processing device 20 could generate corresponding voice input data based on voice messages spoken by the user. The multimedia processing device 16 could then generate corresponding voice keyword data based on the aforementioned voice input data and analyze the voice keyword data with the index table to determine whether there are preset keyword data in the index table that matches the voice keyword data, serving as a reference for subsequent playback mode switching. For example, if the voice processing device 20 generates voice input data including “I am watching Yo-Yo Ma playing the piano”, the multimedia processing device 16 could generate voice keyword data including “Yo-Yo Ma” and “piano performance”. In such a manner, the multimedia processing device 16 can determine that the voice keyword data corresponds to the concert index in the index table and switch the multimedia playback device 14 to a theater mode according to the index relationship between the concert and the theater mode in the index table. On the contrary, if the voice input data does not match any preset keyword data, the multimedia processing device 16 could perform the aforesaid step of querying the network artificial intelligence model 12, and the related description could be reasoned by analogy according to the aforesaid embodiments and omitted herein.

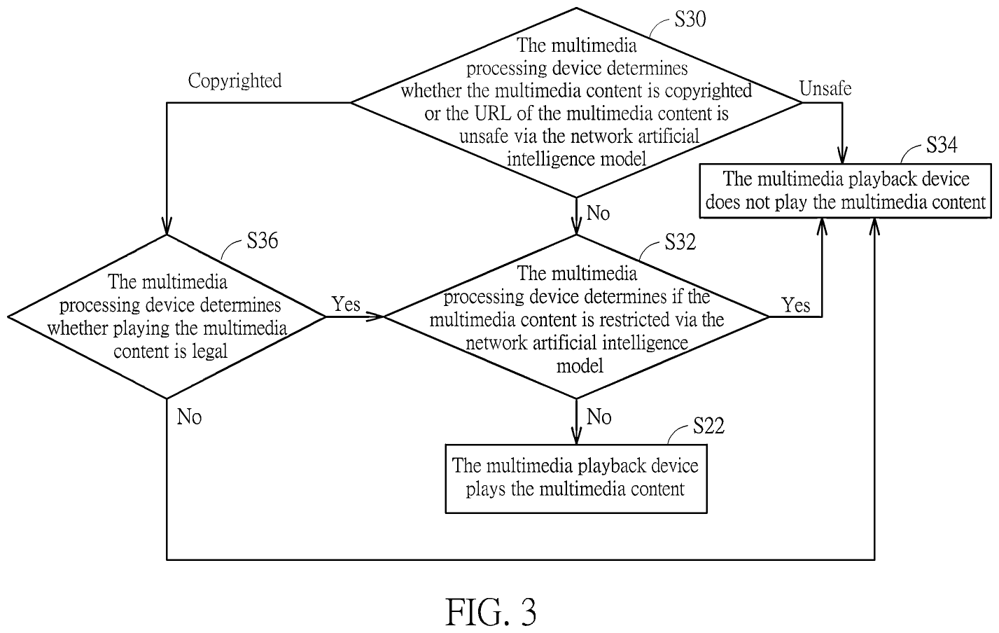

It should be mentioned that the present invention could adopt a source analysis method as shown in FIG. 3 to determine in advance whether to play the aforementioned multimedia content, for ensuring the validity and legality of the multimedia content played by the multimedia playback apparatus 10. Firstly, before performing Step S22, as shown in FIG. 3, the multimedia processing device 16 could upload the relevant data of the multimedia content (e.g., a URL (Uniform Resource Locator) or frame images) to query the network artificial intelligence model 12. In this way, the multimedia processing device 16 can determine in advance whether the multimedia content is copyrighted or the URL of the multimedia content is unsafe (Step S30), thereby deciding whether to play the multimedia content.

During the aforementioned process, if the multimedia processing device 16 determines, based on the answer returned by the network artificial intelligence model 12, that the multimedia content is not copyrighted or that the URL of the multimedia content is a safe URL, the multimedia processing device 16 could perform Step S32 to utilize the network artificial intelligence model 12 to determine if the multimedia content is restricted (e.g., videos being rated 18+and unsuitable for children). At this time, if the multimedia content contains restricted content, the multimedia playback device 14 could choose not to play the multimedia content (Step S34). Otherwise, if there is no restricted content, the multimedia processing device 16 could perform Step S22 to complete the subsequent mode switching steps, thus achieving the multimedia content controlling purpose.

On the other hand, if the multimedia processing device 16 determines, based on the answer returned by the network artificial intelligence model 12, that the URL of the multimedia content is an unsafe URL (e.g., phishing links or fake streaming links), then the multimedia processing device 16 would not play the multimedia content (Step S34). Furthermore, if the multimedia processing device 16 determines that the multimedia content is copyrighted (e.g., streaming videos, movies, TV dramas, animations, etc.), then the multimedia processing device 16 could perform Step S36 to determine whether playing the multimedia content is legal. For example, based on content description information (e.g., auxiliary information obtained from a High Definition Multimedia Interface (HDMI) cable, such as InfoFrame) of the multimedia content, the multimedia processing device 16 could determine whether the multimedia content is played by officially licensed software (or hardware). If so, the process goes to Step S32. If not, the process goes to Step S34. The related description could be reasoned by analogy according to the aforesaid embodiments and omitted herein.

Moreover, the present invention could further adopt a keyword weighting design. For example, the multimedia processing device 16 could extract a plurality of frame images from the multimedia content (e.g., a plurality of frame images within a certain period of playback time, but not limited thereto) to query the network artificial intelligence model 12 in a batch manner. The network artificial intelligence model 12 could then return keywords (e.g., “concert”, “advertisement”) to the multimedia processing device 16 for each query. At this time, the multimedia processing device 16 could assign a weight value to each keyword respectively. As such, if the multimedia processing device 16 determines that a summed weight value for a specific keyword (e.g., “concert”) exceeds a predetermined threshold, the multimedia processing device 16 could analyze the specific keyword with the index table, serving as a reference for subsequent playback mode switching. In such a manner, the possibility of the network artificial intelligence model 12 providing incorrect answers can be effectively reduced, so as to further enhance the precision of the playback mode switching method of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A playback mode switching method comprising:
a multimedia playback apparatus establishing an index table corresponding to a plurality of preset keyword data and a plurality of playback modes;
the multimedia playback apparatus playing multimedia content;
the multimedia playback apparatus extracting at least one frame image from the multimedia content and generating at least one query information to query a network artificial intelligence model;
the network artificial intelligence model transmitting a first keyword data back to the multimedia playback apparatus according to the query information; and
the multimedia playback apparatus analyzing the first keyword data and the index table to determine whether to perform a mode switching operation for adjusting a playback parameter setting of the multimedia content.

2. The playback mode switching method of claim 1 further comprising:
the multimedia playback apparatus generating a voice keyword data according to a voice input data; and
the multimedia playback apparatus analyzing the voice keyword data and the index table to determine whether to perform the mode switching operation.

3. The playback mode switching method of claim 2, wherein when the multimedia playback apparatus determines that the voice input data matches one of the preset keyword data, the multimedia playback apparatus performs the mode switching operation according to the index table.

4. The playback mode switching method of claim 2, wherein when the multimedia playback apparatus determines that the voice input data does not match any preset keyword data, the multimedia playback apparatus queries the network artificial intelligence model according to the at least one query information.

5. The playback mode switching method of claim 1, wherein the multimedia playback apparatus utilizes a translation service to convert a language corresponding to the at least one query information to a default language of the network artificial intelligence model.

6. The playback mode switching method of claim 1 further comprising:
the multimedia playback apparatus sending the index table to the network artificial intelligence model for evolution of the network artificial intelligence model.

7. The playback mode switching method of claim 1, wherein when the multimedia playback apparatus determines that the first keyword data matches one of the preset keyword data, the multimedia playback apparatus performs the mode switching operation according to the index table.

8. The playback mode switching method of claim 1, wherein the at least one query information queries the network artificial intelligence model in a form of a closed-ended choice question about an image type.

9. The playback mode switching method of claim 1, wherein when the multimedia playback apparatus determines that the first keyword data does not match any preset keyword data, the multimedia playback apparatus does not perform the mode switching operation, or alternatively, the multimedia playback apparatus queries the network artificial intelligence model about an image type via a question according to the at least one frame image, and the multimedia playback apparatus establishes a correspondence relationship in the index table between a second keyword data transmitted from the network artificial intelligence model and one of the plurality of playback modes.

10. The playback mode switching method of claim 1, wherein the step of the multimedia playback apparatus playing the multimedia content comprises:
the multimedia playback apparatus sending the multimedia content to the network artificial intelligence model to determine whether the multimedia content is copyrighted or whether a URL (Uniform Resource Locator) of the multimedia content is unsafe, to decide whether to play the multimedia content.

11. The playback mode switching method of claim 10, wherein the multimedia playback apparatus determines a legality of the multimedia content according to a content description information of the multimedia content.

12. The playback mode switching method of claim 10, wherein the multimedia playback apparatus determines whether the multimedia content contains a restricted content via the network artificial intelligence model.

13. The playback mode switching method of claim 1, wherein the first keyword data comprises a plurality of keywords, and the multimedia playback apparatus assigns a weight value to each keyword; when the multimedia playback apparatus determines that a summed weight value for a specific keyword exceeds a threshold, the multimedia playback apparatus analyzes the specific keyword with the index table to determine whether to perform the mode switching operation.

14. A multimedia playback apparatus connected to a network artificial intelligence model, the multimedia playback apparatus comprising:
a multimedia playback device for playing a multimedia content;
a multimedia processing device electrically connected to the multimedia playback device, for establishing in advance an index table corresponding to a plurality of preset keyword data and a plurality of playback modes, extracting at least one frame image from the multimedia content, and generating at least one query information according to the at least one frame image; and
a network transmission device electrically connected to the multimedia processing device, for transmitting a first keyword data returned by the network artificial intelligence model according to the at least one query information back to the multimedia processing device, and the multimedia processing device analyzing the first keyword data and the index table to determine whether to control the multimedia playback device to perform a mode switching operation for adjusting a playback parameter setting of the multimedia content.

15. The multimedia playback apparatus of claim 14, wherein the multimedia playback apparatus further comprises:
a voice processing device electrically connected to the multimedia processing device, for generating a voice input data;
wherein the multimedia processing device generates a voice keyword data according to the voice input data, and the multimedia processing device analyzes the voice keyword data and the index table to determine whether to control the multimedia playback device to perform the mode switching operation.

16. The multimedia playback apparatus of claim 15, wherein when the multimedia processing device determines that the voice input data matches one of the preset keyword data, the multimedia processing device controls the multimedia playback device to perform the mode switching operation according to the index table.

17. The multimedia playback apparatus of claim 15, wherein when the multimedia processing device determines that the voice input data does not match any preset keyword data, the multimedia processing device queries the network artificial intelligence model according to the at least one query information.

18. The multimedia playback apparatus of claim 14, wherein the multimedia processing device utilizes a translation service to convert a language corresponding to the at least one query information to a default language of the network artificial intelligence model.

19. The multimedia playback apparatus of claim 14, wherein the network transmission device sends the index table to the network artificial intelligence model for evolution of the network artificial intelligence model.

20. The multimedia playback apparatus of claim 14, wherein when the multimedia processing device determines that the first keyword data matches one of the preset keyword data, the multimedia processing device controls the multimedia playback device to perform the mode switching operation according to the index table.

21. The multimedia playback apparatus of claim 14, wherein the at least one query information queries the network artificial intelligence model in a form of a closed-ended choice question about an image type.

22. The multimedia playback apparatus of claim 14, wherein when the multimedia processing device determines that the first keyword data does not match any preset keyword data, the multimedia playback device does not perform the mode switching operation, or alternatively, the multimedia processing device queries the network artificial intelligence model about an image type via a question according to the at least one frame image, and the multimedia processing device establishes a correspondence relationship between a second keyword data returned by the network artificial intelligence model and one of the plurality of playback modes in the index table.

23. The multimedia playback apparatus of claim 14, wherein the multimedia processing device determines whether the multimedia content is copyrighted or whether a URL of the multimedia content is unsafe via the network artificial intelligence model, to decide whether to play the multimedia content.

24. The multimedia playback apparatus of claim 23, wherein the multimedia processing device determines a legality of the multimedia content according to a content description information of the multimedia content.

25. The multimedia playback apparatus of claim 23, wherein the multimedia processing device determines whether the multimedia content contains a restricted content via the network artificial intelligence model.

26. The multimedia playback apparatus of claim 14, wherein the first keyword data comprises a plurality of keywords, and the multimedia processing device assigns a weight value to each keyword respectively; when the multimedia processing device determines that a summed weight value for a specific keyword exceeds a threshold, the multimedia processing device analyzes the specific keyword with the index table to determine whether to control the multimedia playback device to perform the mode switching operation.
